(19) United States
(12) Patent Application Publication
(10) Pub. No.: US 2021/0101401 A1
(43) Pub. Date: Apr. 8, 2021

(54) METHOD FOR AUTHENTICATING A FORGERY-PROOF OBJECT

(71) Applicant: HAPA AG, Volketswit (CH)

(72) Inventor: Jean-Luc DEVENOGE, Schwerzenbach (CH)

(21) Appl. No.: 16/499,158

(22) PCT Filed: Mar. 28, 2018
(86) PCT No.: PCT/EP2018/057987

§ 371 Date: Sep. 27, 2019

(30) Foreign Application Priority Data
Mar. 28, 2017 (CH) 00414/17

(51) Int. Cl. B42D 25/305; B42D 25/42; G06K 19/14; G06K 19/06

(52) U.S. Cl. CPC B42D 25/305; G06K 19/06093; G06K 19/14; B42D 25/42

(57) ABSTRACT

A method for producing a forgery-proof object (1), wherein the object is marked with a code (2) and additionally with a marking (3) spaced apart from the code, wherein the method encompasses the following steps:
determining a random position (P_{Z}) of the marking (3) relative to a code position (C_{P}) determined by one or more position features of the code (2) on the object (1);
encoding the object (1) at the determined code position (C_{P})
marking the object (1) with the marking at the random position (P_{Z})
storing position data (ZPD) of the random position (P_{Z}) in a database (6);

The invention relates to a method for authenticating a forgery-proof object according to claim 1, a method for producing a forgery-proof object according to claim 8, a device and a system for producing such an object according to claims 14 and 22, and a forgery-proof object according to claim 25, produced according to claim 8.

### PRIOR ART

Various security systems are known in the prior art for the authentication of printed products. For example, a printing system may be equipped with a special device and/or special coloring means, such as printing colors, ink or toner, in order to place product, manufacturer, or customer-specific authentication information (AI) on the object being printed in addition to the customary information such as address, Unique Identification Code (UID), e.g. in the form of a bar or 2D code, post mark, etc. This can be accomplished e.g. by using special coloring means, with so-called taggants mixed in with them. Such taggants may be materials with special molecular, spectral, luminescent or also magnetic properties. Such coloring means may be imprinted for example in the form of a simple geometrical figure (square, triangle, etc.) in order to make it possible for the recipient, by means of color or spectral analysis or a reading of the magnetic information, to make certain of the authenticity of the product or the proper authorized sender. Alternatively, taggants may also contain encrypted microparticles, micropoints or microlabels, whose optical or acoustical properties can be read e.g. with laser pens, UV light, microscope, special micropoint reading devices or acoustical measuring devices. In this context, radiowave microchips, or so-called micro-RFIDs, can also be used, although this is more costly and expensive.

Other ways of preventing forgeries include the manipulation of optoelectronically readable scripts, such as point or line codes, or the encrypting of such codes. Thus, e.g., from certain geometrical manipulations of corresponding codes which are sent with the print command to the printer it is possible to print and then photograph a code on the printer product that is manipulated in small details yet nevertheless readable. From the photo, the deviations of the code with respect to an unmanipulated code can be detected in the form of a change code and be saved together with the code in a database. The corresponding codes and changes can also be detected with suitable means by the recipient of the printer product and be called up from the database, which confirms the correctness of the sending if the code and the change code match up with the values saved in the database or warns the recipient if they do not match.

Another possibility is the encryption of such codes and saving them in a database, for which the recipient in turn must have the key communicated to him, or access to the database must be made possible.

Quite generally in the prior art examples mentioned, additional hardware expense and knowledge are required on the part of the recipient, so that such methods can only be used in special cases, e.g., for the checking of dubious documents by the sender itself or as an incoming inspection in enterprises which only want to process goods of a particular supplier, but less often for individual checking of individual products or papers sent, such as a checking also by the end consumer.

One problem which the present invention proposes to solve is thus to provide a simplified authentication method with which the identity of a sent object can be verified even without costly special technical equipment acquired only for the authentication.

Another problem is to provide a simple method for producing a forgery-proof object and a device for the corresponding forgery-proof marking, or encoding and marking. Although in the following a marking device or a marking unit shall be mentioned, it is clear to the person skilled in the art that such a device is also suitable for affixing an encoding and shall also be used for both purposes in the various following embodiments.

### DISCLOSURE AND EMBODIMENTS

In a method according to the invention for authenticating a forgery-proof object, there is placed on the at least one object a code and a marking spaced apart from the code, wherein the method involves at least the following steps for the preparation/production of the object, for the detection by a receiver, and for the authentication by the database:

Steps for the preparation/production of the object and the data acquisition, e.g., before mailing:
determining a random position (P_{Z}) of the marking relative to a code position (C_{P}) predetermined on the object (1);
affixing the code and affixing the marking at the random position (P_{Z});
storing position data (ZPD) of the random position (P_{Z}) in a database, wherein the position data (ZPD) may contain coordinates, such as angular, polar, distance, vector coordinates, etc. of the center point, the center of gravity, one or more corner points, or else one or more features of the marking suitable for the position determination. This step may also be performed only during the mailing, for example, if the position data is saved temporarily for a query or relayed to the database;

The affixing of the code and the marking may be done, e.g., by a printing process. It should be noted here that the identifying of the object, i.e., its encoding and/or marking, can also be done, as is customary for the skilled person, by any other identifying methods, such as laser writer, mechanical markings like embossing or stamping, bluing or any other methods, if necessary also by a combination of the corresponding methods. Preferably, the marking with the code takes place in one step, such as a printing process, but the marking can also be done separately in a step following the encoding, such as in the case of precoded objects. The method is also especially suitable for the printing of various kinds of printed matter, such as documents, envelopes, packages, etc.

Steps for the detection, e.g., for a recipient of the at least one object being individually identified:
joint detecting of the position (P_{Z}) of the marking affixed to the object and of the code position (C_{P}) by a preferably optical detection system and providing of detected image data or determination of the position data (GPD), e.g., directly or from the detected image data, by the detection system, based for example on a software-implemented detection algorithm, such as a position detection program, and providing of the position data (GPD);
sending of the provided image data or the determined position data (GPD) to the database by the detection system;
displaying the result of the authentication of a comparison performed in the database of the data records (ZPD and GPB) (see below) by the detection system.

Steps for the authentication by the database:
determining of the position data (GPD) from the detected image data by the database and comparing of the stored position data (ZPD) with the determined position data (GPD) by a comparator communicating with the database, or
comparing of the stored position data (ZPD) with the determined position data (GPD) by a comparator integrated in the database for the automatic comparison and communicating with the database.
sending back a confirmation of the authentication if the stored position data (ZPD) matches up with the determined or mailed position data (GPD) to the detection system or
sending back a rejection of the authentication if the stored position data (ZPD) does not match up with the determined or mailed position data (GPD) to the detection system.

The return sending can be done by the database, especially if the database, comparator and sending/receiving unit of the database form a single unit; but if the comparator only communicates with the database, it can also be done alternatively directly by the comparator, if this is connected to a sending unit.

In addition, there may also be provided a return sending of an error message to the detection system, if the determination of a positive or negative authentication is not possible by comparing the stored position data (ZPD) with the determined position data (GPD), for example because one of the data sets (GPD, ZPD) is faulty or incomplete.

The random position (P_{Z}) can be established by a function with respect to the code position (C_{P}), or with respect to one or more position features of the code position. This may be, for example, the coordinates of the inner or outer end point of one or more particular lines of a line code with respect to the object, one or more corner points of a 2D code, the center of gravity, a (possibly imaginary) base or side line of a code, or the like. In addition, information depending on the particular object being marked, such as permitted and forbidden regions for the marking, for example the address field or the franking region of a letter, may be saved as further function parameters in the memory of a printer, for example, or be sent along with the print command to the printer. Such a function may also be represented as an algorithm in a software program. The function or the software program can rely on a random number generator for determining the random position.

One or more evaluation systems, such as arithmetic units, memory cards, etc., may be integrated both in the detection system and in the database DB. Alternatively, such evaluation systems may also be situated, for example, in movable storage media such as dongles or memory cards, or in PCs, and be merely connected to the detection system or database. By detection system or database DB is therefore meant here a corresponding system in its most general form, although integrated systems are preferable, especially in regard to the detection system, because of the compact design and the associated flexibility. For example, an especially compact system can be realized with the aid of a mobile telephone with integrated camera, by which images can be sent either directly to the database or the position data may at first be determined by means of a software program, e.g., one in the form of a so-called app, and then be sent, encrypted for example, to the database. The determination of the position data may be done here, as with other optical detection systems, especially cameras, either directly, e.g., by measuring the geometries, reference angles, and/or distances, etc., or preferably on account of the lower expense from the detected image data by means of an evaluation program.

The affixing of the code may be done in a preparatory step, by which precoded objects such as postal mailings or documents can also be further marked afterwards in forgery-proof manner. The code used here may be not only common codes, such as those mentioned above, but also franking marks or one or more lines of an address.

Usually the affixing of the code and the marking, especially when a high relative position accuracy is required between code and marking, for example in order to make possible the largest and thus most forgery-proof number of random positions (P_{Z}) possible, is done with an encoding/marking device, such as a printer, and preferably in a single step of the method, since this does away with the need for once again clamping and thus exact positioning of the object in the marking device.

The detection system may be a camera used by a user or by an automatic inspection system, for example, which provides image data of the jointly detected positions of the code and the marking, or with the aid of a position detection program, such as one in the form of an app downloadable from the Internet or a data storage medium, from the optical detection performed for the code position (C_{P}) of the code and the random position (P_{Z}) of the marking on the object, which automatically determines the position data (GPD). The determining of the position data (GPD) can be done directly, e.g., by angle measurements between various geometrical features of the code and the marking, for example at one or more given distances from the image plane or from the image data of one or more jointly detected positions.

After this, the provided image data or position data (GPD) can be relayed by the camera itself or a sending unit connected to the camera to the database, processed and compared by the database, or only be compared. The response automatically generated by the database (confirm/reject) can likewise be displayed by the sending unit or on the camera. The response may also show a failed authentication, for example due to distance being too large or small, missing position points in the photograph, or defective data transmission, etc.

Such a system can be realized with a camera built into a mobile telephone in an especially simple and user-friendly manner. Advantageously, in this case, the image data is processed by a position detection program, such as an app, see above, directly on the mobile telephone, making it possible to greatly reduce the volume of data being transmitted.

A corresponding app may also contain instructions for performing the optical detection with the camera for the user.

A further problem which the invention proposes to solve is to provide a method for producing a forgery-proof object, wherein the object is encoded with a code and additionally marked with a marking spaced apart from the code, wherein the method encompasses the following steps:
determining a random position (P_{Z}) of the marking relative to a code position (C_{P}) determined by one or more position features of the code on the object;
encoding the object at the determined code position (C_{P})
marking the object with the marking at the random position (P_{Z});
storing position data (ZPD) of the random position (P_{Z}) in a database.

Also in this method the random position (P_{Z}) may be established by a function with respect to the code position (C_{P}), wherein the function uses one or more position features of the code position, i.e., as a reference point, or as reference points for determining/calculating the position data (ZPD) of the random position (P_{Z}), for example with the help of a random number generators.

Also in this method the encoding may be done in a preparatory step or in a step, for example by affixing the code and the marking with an encoding/marking device in a step of the method, e.g., printed in a printing process.

The invention also relates to an object produced by the above described method, especially types of printed matter produced in this way. By types of printed matter is meant here documents of every kind, envelopes, wrappings, but also packages in particular, which serve as carriers of information (e.g., for address, zip code, line code, 2D code, product code, manufacturer information, advertising). One may mention here for example the packages of especially valuable goods or those which are especially critical in terms of risks of a forgery, such as delicate chemicals and/or medications or the like. Thus, blister packs, such as those for medical products, may also be encoded accordingly, i.e., provided with a code, and be marked with a marking positioned in a random position relative to the code.

A further problem which the invention proposes to solve is to provide a device for the marking of an object (a marking device), having a control unit, a marking unit and at least one input and output for receiving and sending of data, wherein the control unit comprises a position generator, which is configured to generate position data (ZPD) of a random position (P_{Z}) on the basis of code position data (CPD) of a code position (C_{P}) of a code which is determined or established on the object and which relays this to the marking unit for affixing the marking, and to the output. Preferably, codes are used which are determined but not yet placed on the object, making possible a joint affixing of all information, especially the code and the marking, on the object, for example in a single printing process. At least in the case of precoded objects, it is always advantageous to use the same determined code position (C_{P}), which is then permanently stored as code position data (CPD) in a memory coordinated with the position generator of the device, and which can be called up by the random generator at the output for calculating the random position when a marking or encoding command is given, such as a print command. On the other hand, the code position data (CPD) may also be present via the output, e.g., together with the print command, and be relayed for example via the control unit to the position generator, which in turn calculates the position data (ZPD) of the random position (P_{Z}) and provides this for the encoding/marking process, such as a printing process with a printing unit.

Alternatively, when using nonstandardized precoded objects, the code position (C_{P}) may also be determined, e.g., immediately before affixing the marking, but for this an optical detection and data processing needs to be provided in advance.

The relaying of the position data (ZPD) of the random position to the marking unit is usually done not directly, but rather via the control unit of the device and/or a temporary buffer storage for example, associated with the position generator or the control unit. The encoding/marking unit may be any given printing unit, such as an inkjet head or the imaging device of a laser printer.

The relaying of the position data (ZPD) to the output need not be done at once, the data may also be provided in a memory for retrieval, e.g., for retrieval by an external database. The control unit may also retrieve the data from such a memory, in order to affix the marking either in addition to information already placed on the object, such as code, address, franking, or along with this information. A joint affixing of at least the code and the marking is preferable, due to the easily managed position tolerances with only a single clamping for the affixing of the information.

If a code is used which is determined but not yet placed on the object, then all information, especially code and marking, but also information such as address or franking, can be placed on the object in a printing process, for example.

The position generator may comprise a logic circuit for determining the random position (P_{Z}) and for generating the position data (ZPD), or be configured as such, and it may comprise a random number generator. Alternatively, the position generator as well as the random number generator may be partly or entirely in the form of an algorithm, such as a software program.

In every case, the position generator may be implemented in the control unit of the device.

The marking device may be a printer, such as an ink jet or laser printer.

The invention also relates to a system for the forgery-proof marking of an object, consisting of a marking device connected to an external control unit, wherein the system comprises an input and output for receiving and sending of data and an interface between the marking device and the control unit for exchanging of data. The marking device comprises a control unit for the marking, having a position generator which, on the basis of code position data (CPD) of a code position (C_{P}) of a code determined or established on the object, generates position data (ZPD) of a random position (P_{Z}) and relays this to the output and, via the interface, to the control unit of the marking device.

The control unit may be a dongle, e.g., having a special USB-based microprocessor or in the form of a programmed USB stick, wherein the marking device, such as a printer, comprises the input and output and relays on the one hand the received position data (ZPD) via the interface to the output and on the other hand to the marking unit. This can usually occur via the control unit.

On the other hand, the control unit may be a PC or a system control unit which itself comprises an input and output and communicates by the interface with the marking device. The position data (ZPD) in this case are relayed from the control unit via the output OUT, for example to the database, and via the interface to the marking device.

Although the invention has been explained in the preceding discussion with the aid of various embodiments and specific examples, it also encompasses all combinations of embodiments with features which have been demonstrated in connection with other examples, as long as this does not appear obviously senseless to the skilled person.

### DESCRIPTION OF THE FIGURES

In the following, the invention shall be described as an example with the aid of figures. There are shown:

FIG. 1 A marking device with forgery-proof packaging;

FIG. 2 A detection system in interaction

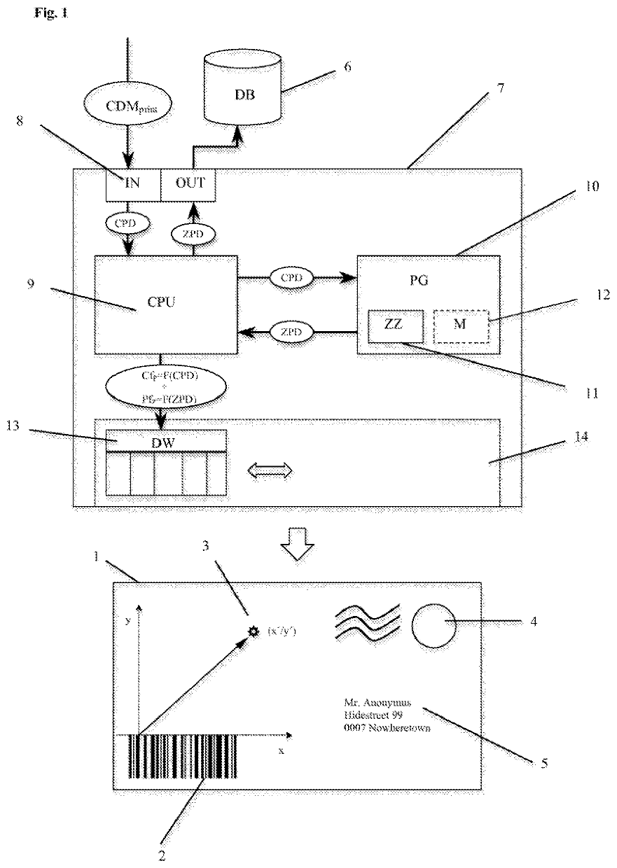

FIG. 1 shows by the example of a marking device configured as a printer 7 how such a device can be constructed according to the invention in order to produce a forgery-proof package 1, as shown schematically. The printer 7 has an input/output 8 for exchanging data, by which a print command CDMₚᵣᵢₙₜ is relayed to the control unit 9 of the printer. The print command here contains, besides the usual information for printing in the address field 5 and the franking field 4, also the command for printing a code 2, here a line code, as well as corresponding code position data (CPD). The code position data (CPD) here is at first relayed to a position generator 10, which on the one hand can be built, as shown, in the form of a microprocessor, but on the other hand can also be an integrated component of the control unit 9. Furthermore, the position generator 10 comprises a random number generator 11, which depending on the requirements for the forgery prevention, can be designed as a deterministic one, such as a software algorithm, i.e., an algorithm implemented in a software program, or a nondeterministic one, such as a physical random number generator 11. Thus, the position generator 10 generates the position data (ZPD) of the random position (P_{Z}) of the marking 3, which in one simple instance, as represented on the package 1 shown underneath, comprises at least the coordinates (x′, y′) or (r′/Ø′) of the respectively chosen coordinate system in a P. The determination of the coordinate system is likewise done here by the position generator 10. In the present case, the zero point of the coordinate system is given by the upper right edge of the 3rd code line and the orientation of the coordinate system is with the x-axis parallel to the longitudinal direction of the code, or the package. This information (coordinate basis) is also usually contained in the position data (ZPD). The latter is transferred to the control unit 9, which constructs from this the print function Pf_{Z}=F(ZPD) for the printing of the marking 3 in addition to the print function Cf_{P}=F(CPD) for the printing of the code 2 and relays this to the printing unit 13. Alternatively, depending on the print protocol used, the print function of the code may already be present at the input, so that the control unit 9 can send it to the printing unit 13 without further processing. In such a case, the random generator creates the position data (ZPD) and the print function Pf_{Z} from the print function of the code Cf_{P} and sends both of these to the control unit 9. In any case, the control unit 9 sends the print function Cf_{P}=F(CPD) to the printing unit 13 and relays the position data (ZPD) to the output OUT. The latter may be sent at once or with a time delay, e.g., only after retrieval from the database 6, for which a memory M/12 shown here by broken line can be provided in the position generator 10 for the retrievable temporary storage of the position data (ZPD).

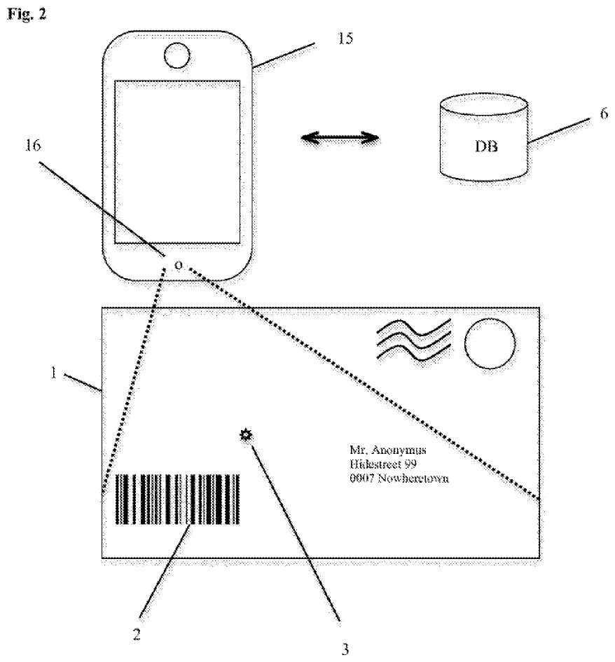

In another embodiment, the data for the coordinate basis can also be sent already with the print command CDMₚᵣᵢₙₜ to the printer. In this case, however, this data must also be present in the database 6 or in the mobile telephone 15 described in FIG. 2, or in the app loaded onto it, which makes it difficult to change the coordinate basis, for example as an additional security measure.

The printing unit 13 is shown here schematically as an inkjet printing unit 13, traveling in the printing shaft 14 on a carriage, not shown.

FIG. 2 shows schematically the sequence of the authentication by the recipient. The code and marking on the address side of the package are photographed with the camera 16 of a mobile telephone 15, on which a position detection program or a position detection app has been installed, and the position data (GPD) of the random position (P_{Z}) is ascertained. The position data (GPD) is sent to the database 6, or to a computer connected to it and not shown here, whereupon the position data (ZPD) stored there is compared with the aid of a comparator of the database, or the computer, to the position data (GPD) which has been determined and sent, and the result of the authentication is sent back to the mobile telephone 15 for displaying to the user.

### LIST OF REFERENCE NUMBERS

1 Packaging, envelope, document, mailed object
2 Code
3 Marking
4 Franking field
5 Address field
6 Database
7 Marking device, printer
8 Input/output
9 Control unit (CPU) of the marking device, printer
10 Position generator PG
11 Random number generator
12 Memory
13 Marking unit, printing unit
14 Printing shaft
15 Detection system, mobile telephone
16 Camera

1. A method for authenticating a forgery-proof object, wherein the object is marked with a code and additionally with a marking spaced apart from the code, characterized in that the method encompasses the following steps:
determining a random position of the marking relative to a code position predetermined on the object;
affixing the code and affixing the marking at the random position;
storing position data of the random position in a database;
joint detecting of the position of the marking affixed to the object and of the code position by a detection system and providing of image data or determination of the position data by the detection system and providing of the position data so determined;
sending of the provided image data or the determined position data to the database by the detection system;
determining of the position data from the image data by the database and comparing of the stored position data with the determined position data by a comparator communicating with the database, or
comparing of the stored position data with the determined position data by a comparator communicating with the database and
sending a confirmation of the authentication back to the detection system if the stored position data matches up with the determined position data or
sending a rejection of the authentication back to the detection system if the stored position data does not match up with the determined position data;
displaying the result of the authentication by the detection system.

2. The method according to claim 1, characterized in that the random position is determined by a function relative to the code position.

3. The method according to claim 2, characterized in that the function uses one or more position features of the code position.

4. The method according to claim 2, characterized in that the function uses a random number generator for determining the random position.

5. The method according to claim 1, characterized in that the affixing of the code is done in a preparatory step.

6. The method according to claim 1, characterized in that the affixing of the code and the marking is done with a marking device, preferably in one step of the method.

7. The method according to claim 1, characterized in that the detection system comprises a camera, which provides image data for the relaying, or which determines with the aid of a position detection program the position data from the optical detection of the code position and the random position on the object and provides it for the relaying.

8. The method according to claim 1, characterized in that the detection system comprises a mobile telephone with a camera.

9. A method for producing a forgery-proof object, wherein the object is encoded with a code and additionally is marked with a marking spaced apart from the code, characterized in that the method encompasses the following steps:
determining a random position of the marking relative to a code position determined by one or more position features of the code on the object;
encoding the object at the determined code position
marking the object with the marking at the random position
storing position data of the random position in a database.

10. The method according to claim 9, characterized in that the random position is determined by a function relative to the code position.

11. The method according to claim 10, characterized in that the function uses one or more position features of the code position.

12. The method according to claim 10, characterized in that the function uses a random number generator for determining the random position.

13. The method according to claim 9, characterized in that the encoding is done in a preparatory step.

14. The method according to claim 9, characterized in that a position generator is used for determining the random position and the position generator and/or random number generator are partly or entirely in the form of a software program with implemented algorithm.

15. A device for marking an object, having a control unit, a marking unit and at least one input and output for receiving and sending of data, characterized in that the control unit comprises a position generator, which is configured to generate position data of a random position on the basis of code position data of a code position of a code which is determined or established on the object and which relays this to the marking unit for affixing the marking and to the output OUT.

16. The device according to claim 15, characterized in that it is configured to receive the code position data via the input and to relay this to the position generator.

17. The device according to claim 16, characterized in that it comprises a memory connected to the position generator for code position data which can be saved there permanently.

18. The device according to claim 15, characterized in that the position generator comprises a random number generator.

19. The device according to claim 15, characterized in that the position generator comprises a logic circuit for determining the random position and for generating the position data.

20. The device according to claim 15, characterized in that the position generator and/or random number generator are partly or entirely implemented in the form of a software program.

21. The device according to claim 15, characterized in that the position generator is implemented in the control unit of the device.

22. The device according to claim 15, characterized in that the device is a printer, preferably an ink jet or laser printer.

23. A system for the forgery-proof marking of an object, consisting of a marking device connected to an external control unit, wherein the system comprises an input and output for receiving and sending of data and an interface between the marking device and the control unit for exchanging of data, wherein the marking device comprises a control unit for the marking, characterized in that the control unit comprises a position generator which, on the basis of code position data of a code position of a code determined or established on the object, generates position data of a random position and relays this to the output OUT and, via the interface, to the control unit of the marking device.

24. The system according to claim 23, characterized in that the control unit is a dongle, the marking device comprises an input and output and relays the position data from the control unit also via the interface or via the interface and the control unit to the output OUT.

25. The system according to claim 24, characterized in that the control unit comprises an input and output and is a PC or system control unit.

26. An object produced by the method according to claim 9.

27. The object according to claim 26, characterized in that the object is a kind of printed matter, comprising a package.
